(19) United States
(12) Patent Application Publication
(10) Pub. No.: US 2012/0102492 A1
(43) Pub. Date: Apr. 26, 2012

(54) POWER SUPPLY AND CONTROL METHOD THEREOF

(75) Inventor: Tetsuki IWATA, Niiza-shi (JP)

(73) Assignee: Sanken Electric Co., Ltd., Niiza-shi (JP)

(21) Appl. No.: 13/276,683

(22) Filed: Oct. 19, 2011

(30) Foreign Application Priority Data
Oct. 25, 2010 (JP) 2010-238760

(51) Int. Cl. G06F 9/455

(52) U.S. Cl. 718/1

(57) ABSTRACT

A power supply for feeding power to a computer comprises an instruction acquisition unit configured to acquire an identifier of a virtual machine and an instruction for the virtual machine, the virtual machine being run in emulation by a virtual host executed on the computer; and a virtual machine management unit configured to input an operation instruction for the virtual machine to the virtual machine on the basis of the acquisition by the instruction acquisition unit.

### CROSS-REFERENCE TO RELATED APPLICATIONS

This application is based upon and claims the benefit of priority from the prior Japanese Patent Application No. 2010-238760 (filed Oct. 25, 2010); the entire contents of which are incorporated herein by reference.

### BACKGROUND OF THE INVENTION

1. Field of the Invention

The present invention relates to a power supply for feeding power to a computer, and a control method of the power supply.

2. Description of the Related Art

Virtualization management is generally used for effective utilization of the resources of physical computers. The virtualization management uses the physical computers as virtual hosts. Each virtual host is configured to run one or multiple virtual machines (VMs) in emulation. In the virtualization management, a VM is sometimes migrated to a different virtual host depending upon the running situations of the VMs. Using a structure that allows flexible migration of a VM to any virtual host makes it possible to effectively utilize the resources of the physical computers.

Meanwhile, there are methods that use a power control device to reduce the power consumption of the physical computers (see Japanese Patent Application Publication No. 2008-269249, for example). In the method described in Japanese Patent Application Publication No. 2008-269249, the power control device collects the load statuses of systems, migrates a system to a given physical computer on the basis of the load statuses, and turns off the power of the unselected physical computer. By causing the power control device to perform both virtualization management and power management as described above, the power consumption of the physical computers can be expected to be reduced.

### SUMMARY OF THE INVENTION

However, the method described in Japanese Patent Application Publication No. 2008-269249 has a problem that the power control device becomes unable to perform not only the power management but also the virtualization management if there is a power fault in the power supply feeding power to the power control device.

Further, if the ON/OFF of the power of each physical computer is not in synchronization with the virtualization management, a VM may possibly be migrated to a physical computer whose power is off. In the case of the method described in Japanese Patent Application Publication No. 2008-269249, each power supply may be also turned on or off by accidental failure of power, manual operation of turning on or off the power supply, or the like, besides the control of the power control device. Accordingly, a VM may possibly be migrated to a physical computer whose power is off, as in the case where the virtualization management is not in synchronization with the ON/OFF of the power.

Due to such circumstances, a technique to synchronize power management and virtualization management to improve the reliability of the whole system has been expected to be developed.

Therefore, an object of the present invention is to provide a power supply and a control method thereof which are capable of improving the reliability of power management and virtualization management.

In order to achieve the above object, the first characteristic of the present invention is related to the power supply for feeding power to a computer. The power supply according to the first characteristic of the present invention includes: an instruction acquisition unit configured to acquire an identifier of a virtual machine and an instruction for the virtual machine, the virtual machine being run in emulation by a virtual host executed on the computer; and a virtual machine management unit configured to input an operation instruction for the virtual machine to the virtual machine on the basis of the acquisition by the instruction acquisition unit.

The second characteristic of the present invention is related to the control method of a power supply for feeding power to a computer. The control method of the power supply according to the second characteristic of the present invention includes the steps of: acquiring an identifier of a virtual machine and an instruction for the virtual machine, the virtual machine being run in emulation by a virtual host executed on the computer; and inputting an operation instruction for the virtual machine to the virtual machine.

### BRIEF DESCRIPTION OF THE DRAWINGS

FIG. 1 is a block diagram for describing a power supply of an embodiment of the present invention.

FIG. 2 is a system configuration diagram for describing a power supply system of the embodiment of the present invention.

FIG. 3 is a diagram for describing an example of a screen displaying the system configuration of the power supply system, in the case of the power supply of the embodiment of the present invention.

FIG. 4 is a diagram for describing an example of the data structure of and data in target data in the power supply of the embodiment of the present invention.

FIG. 5 is a diagram for describing an example of the data structure of and data in power supply state data in the power supply of the embodiment of the present invention.

FIG. 6 is a diagram for describing an example of the data structure of and data in virtual host state data in the power supply of the embodiment of the present invention.

FIG. 7 is a diagram for describing an example of the data structure of and data in VM state data in the power supply of the embodiment of the present invention.

FIGS. 8A to 8C are diagrams for describing examples of power supply operation data in the power supply of the embodiment of the present invention.

FIG. 9 is a diagram for describing an example of virtual host operation data in the power supply of the embodiment of the present invention.

FIG. 10 is a diagram for describing an example of VM operation data in the power supply of the embodiment of the present invention.

FIG. 11 is a flowchart for describing control processing performed by control unit in the power supply of the embodiment of the present invention.

FIGS. 12A to 12C are diagrams for describing examples of a screen for inputting an operation instruction for a power supply, in the case of the power supply of the embodiment of the present invention.

FIG. 13 is a diagram for describing an example of a screen for inputting an operation instruction for a virtual host, in the case of the power supply of the embodiment of the present invention.

FIG. 14 is a diagram for describing an example of a screen for inputting an operation instruction for a VM, in the case of the power supply of the embodiment of the present invention.

FIG. 15 is a diagram for describing an example of a screen for inputting an instruction to change a parameter of a VM, in the case of the power supply of the embodiment of the present invention.

FIG. 16 is a diagram for describing an example of a screen for inputting an instruction to migrate a VM, in the case of the power supply of the embodiment of the present invention.

FIG. 17 is a diagram for describing an example of a screen in which an instruction to migrate a VM is inputted through drag-and-drop, in the case of the power supply of the embodiment of the present invention.

FIG. 18 is a system configuration diagram for describing the power supply system after migration of some VMs.

FIG. 19 is a diagram for describing an example of a screen displaying the system configuration of the power supply system after the migration, in the case of the power supply of the embodiment of the present invention.

FIG. 20 is a system configuration diagram for describing a power supply system of a modification of the present invention.

FIG. 21 is a block diagram for describing a power supply and a management terminal of the modification of the present invention.

FIG. 22 is a diagram for describing an example of a screen displaying the states of VMs, in the case of the management terminal of the modification of the present invention.

FIG. 23 is a diagram for describing an example of a screen displaying log data, in the case of the management terminal of the modification of the present invention.

### DETAILED DESCRIPTION OF THE PREFERRED EMBODIMENTS

Embodiments of the present invention will be described next with reference to the drawings. In the following description of the drawings, the same or similar portions are denoted by the same or similar reference signs.

First of all, in the embodiments of the present invention, a “physical computer” is a general computer including a central processing unit (CPU), a storage device, and the like. Specifically, a “physical computer” is a computer such as a personal computer, a server, or a blade server. Moreover, a “virtual host” is implemented on a physical computer by executing a host OS on the physical computer. One virtual host can run one or more VMs. A “VM” is a virtual computer obtained by emulating another computer as software on one virtual host.

A “virtual system” includes a physical computer, a physical storage, a physical network, and the like. The whole virtual system functions as one or more VMs. “Virtualization management” manages virtual infrastructures constructing a virtual system and controls the running of one or more VMs. The control by the virtualization management may result in migration of a VM to a different virtual host.

“Migration” is to move a virtual infrastructure to a different physical infrastructure. Generally, migration includes server migration (live migration), storage migration, network migration, and the like. Server migration is to move a VM running on a virtual host to a different virtual host by memory copy. Storage migration is to move a virtual storage on a physical storage to a different physical storage. Network migration is to move a virtual network on a physical network to a different physical network by copying data. In the embodiments of the present invention, migration refers particularly to server migration. Note that in server migration, a VM may be migrated while it is running or stopped.

Operations for a VM include “shutdown,” “power on,” “power off,” and the like. “Shutdown” is to shut down a guest OS installed in the VM to power off the VM. “Power on” is to turn on the power of the VM. “Power off” is to turn off the power of the VM.

Operations for a virtual host include “shutdown,” “switch to maintenance mode,” “reboot,” “power on,” and the like. “Shutdown” is to shut down a virtual host OS running on the physical computer. In this event, the virtual host needs to be in a maintenance mode. “Switch to maintenance mode” is to disable any operation to the VM running on the virtual host. “Reboot” is to reboot the virtual host OS running on the physical computer. In this event, the virtual host needs to be in the maintenance mode. “Power on” is to turn on the power of the physical computer running the virtual host to make the virtual host OS run.

A “power supply” is an apparatus configured to feed power to virtual infrastructures, as well as to measure and cut the power. Specifically, a “power supply” is an alternating current (AC) power supply, a direct current (DC) power supply, an uninterruptible power supply (UPS), a power distribution unit (PDU), or the like.

“Power management” is control that allows stable feed of power to infrastructures.

### Embodiment

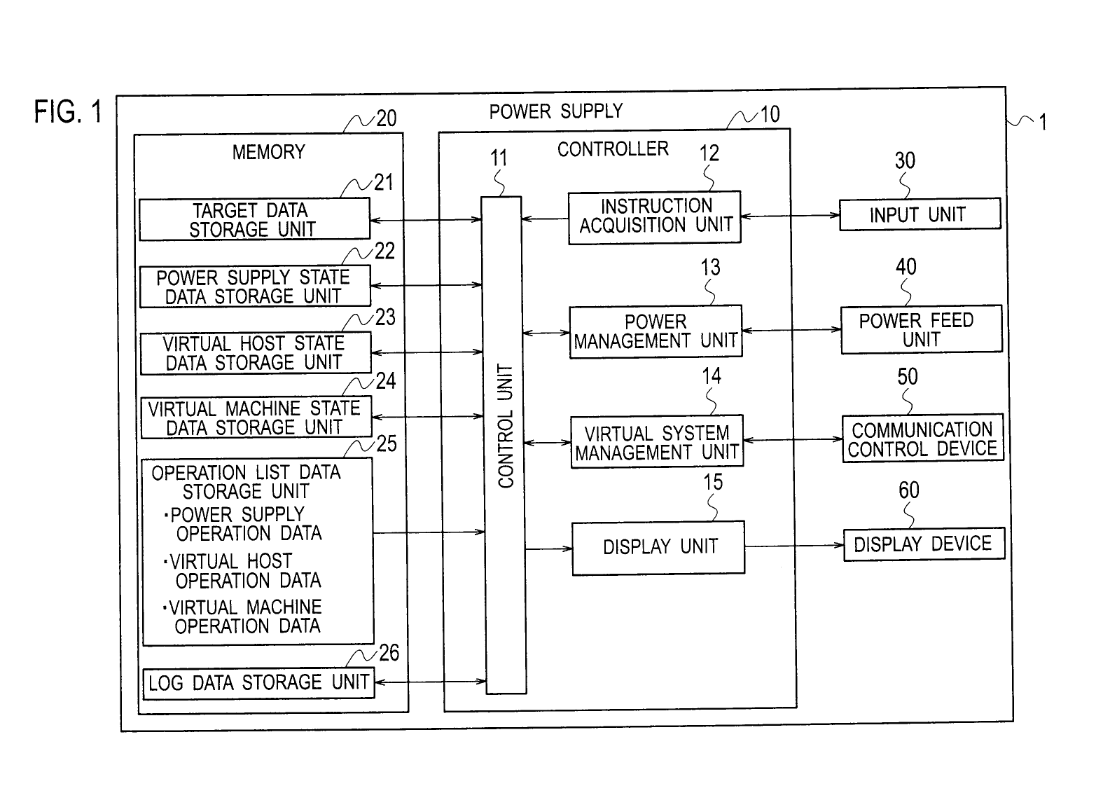

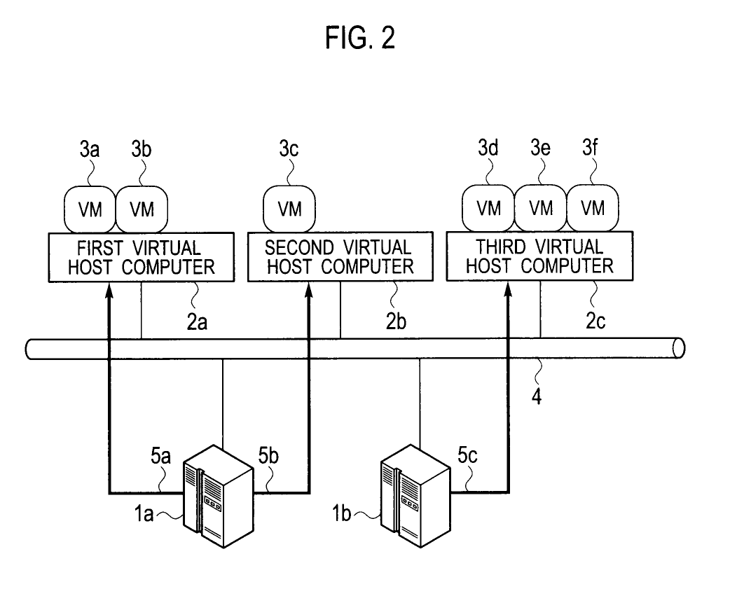

First, a power supply 1 of an embodiment of the present invention shown in FIG. 1 is used in a power supply system of the embodiment of the present invention shown in FIG. 2.

The power supply 1 of the embodiment of the present invention is used in a power supply system as shown in FIG. 2. In FIG. 2, the power supply system of the embodiment of the present invention includes a first power supply 1a, a second power supply 1b, a first virtual host computer 2a, a second virtual host computer 2b, and a third virtual host computer 2c. These apparatuses are connected to each other through a communication network 4. The communication network 4 is a LAN, for example.

The first power supply 1a includes a first outlet 5a and a second outlet 5b. The second power supply 1b includes a third outlet 5c. The first power supply 1a is configured to feed power to the first virtual host computer 2a through the first outlet 5a and to the second virtual host computer 2b through the second outlet 5b. The second power supply 1b is configured to feed power to the third virtual host computer 2c through the third outlet 5c. In the example shown in FIG. 2, each bold arrow shows the feed of power from the power supply to the virtual host computer.

The virtual host computer 2 is a physical computer and configured to run one or more VMs in emulation. The first virtual host computer 2a runs a first VM 3a and a second VM 3b in emulation. The second virtual host computer 2b runs a third VM 3c in emulation. The third virtual host computer 2c runs a fourth VM 3d, a fifth VM 3e, and a sixth VM 3f in emulation.

In the embodiment of the present invention, the power supply 1 is configured to perform both power management and virtualization management. In the power management, the power supply 1 controls the feed of power to the virtual host computer 2. In the virtualization management, the power supply 1: controls the virtual host computer 2 and the VM 3 during an event where the power is shut off; controls resources and parameters allocated to the VM 3 on the virtual host computer 2; controls migration of the VM 3; and controls command transmission to the virtual host computer 2 and to the VM 3.

Note that in the embodiment, the first power supply 1a and the second power supply 1b are expressed as “power supply 1” when it is not particularly necessary to distinguish them. The same applies to the virtual host computers (virtual hosts) and the VMs.

As shown in FIG. 1, the power supply 1 of the embodiment of the present invention includes an input unit 30 and a displaydevice 60. The power supply 1 is configured to display information on the virtual host 2, information on the VM 3, and the like through the displaydevice 60, the virtual host 2 being executed on the computer which the power supply 1 feeds power to. The user can input operation instructions to the power supply 1, the virtual host 2, and the VM 3 by using the input unit 30 of the power supply 1.

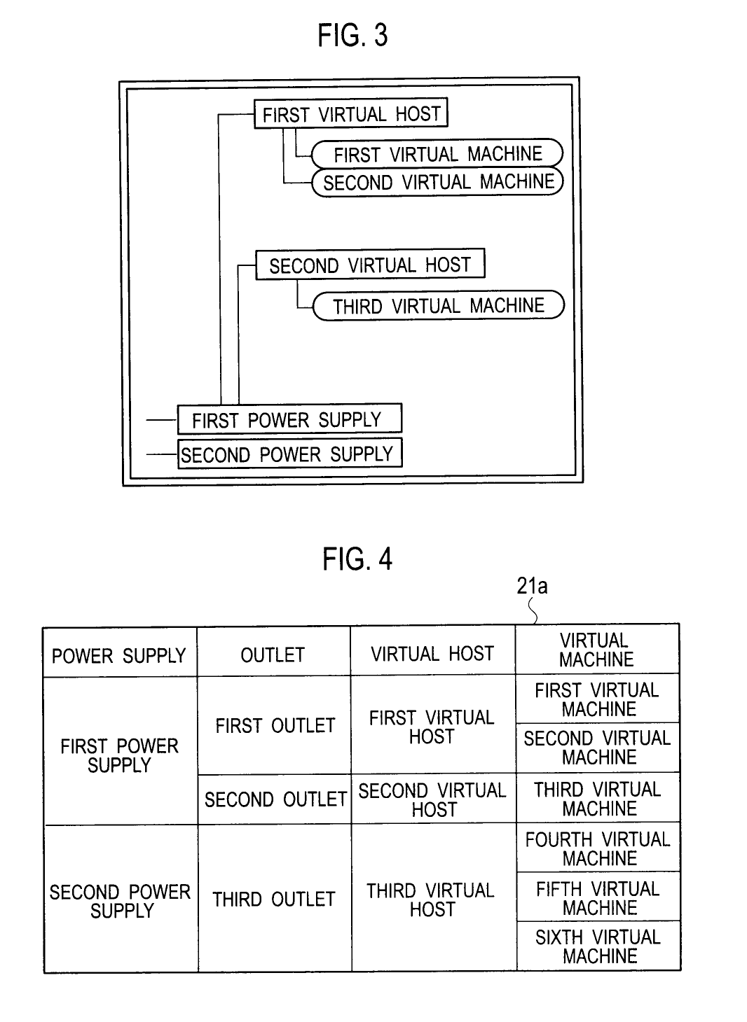

The displaydevice 60 of the power supply 1 is configured to display a screen as shown in FIG. 3, for example. The screen shown in FIG. 3 displays the configuration of the power supply system shown in FIG. 2 in the form of a tree structure. The screen in FIG. 3 shows that the power supply system shown in FIG. 2 includes the first power supply 1a and the second power supply 1b. The screen in FIG. 3 shows that the first power supply 1a is feeding power to the first virtual host 2a and the second virtual host 2b. The screen in FIG. 3 shows that the first virtual host 2a is running the first VM 3a and the second VM 3b in emulation and that the second virtual host 2b is running the third VM 3c in emulation.

The screen shown in FIG. 3 displays no information on the third virtual host 2c connected to the second power supply 1b. When the user selects the “SECOND POWER SUPPLY” icon in the screen shown in FIG. 3 through the input unit 30, the displaydevice 60 displays, in a tree structure, the identifier of the third virtual host 2c connected to the second power supply 1b and of the fourth VM 3d, the fifth VM 3e, and the sixth VM 3f run by the third virtual host 2c in emulation.

In the example shown in FIG. 3, displayed is one of the information on the first power supply 1a and the information on the second power supply 1b. In this way, the information on the power supply system can be displayed efficiently on the limited display screen of the displaydevice 60 even when many virtual hosts 2 and VMs 3 are running in the power supply system. Meanwhile, although the information on the VMs run by the first virtual host 2a in emulation is displayed in FIG. 3, the information may be displayed only by selecting the “FIRST VIRTUAL HOST” icon in the screen shown in FIG. 3, for example. Moreover, the information on all the virtual hosts and VMs may be displayed depending upon the scale of the power supply system. As described, various modes are possible in displaying the power supplies, the virtual hosts, and the VMs.

The power supply 1 of the embodiment of the present invention will be described with reference to FIG. 1. The power supply 1 includes a controller 10, a memory 20, the input unit 30, a power feed unit 40, a communication control device 50, and the display device 60.

The controller 10 is a control device configured to control processing of the power supper device 1. The memory 20 is a storage device configured to store: program data of a firmware program and the like executed on the power supply 1; data to be processed by the controller 10; and the like.

The input unit 30 is an interface through which the user inputs information to the controller of the power supply 1. The input unit 30 may be buttons provided to the enclosure of the power supply 1, or a touch panel provided to the display device 60. Alternatively, the input unit 30 may be a keyboard and a mouse connected to the power supply 1 through cables or the like.

The power feed unit 40 is configured to feed power to the computer connected to the power supply 1. The power feed unit 40 includes multiple outlets and therefore can feed power to multiple computers. The communication control device 50 is a device for communicating with the other power supply, computers, and the like and is a LAN adapter, for example.

The display device 60 is a display device such as a liquid crystal display for allowing the user to visually recognize the information on the power supply 1 and the like. The display device 60 may be a display device mounted to the enclosure of the power supply 1, or a display device connected thereto through a cable or the like.

The memory 20 has a storage area for the program data and also has a target data storage unit 21, a power supply state data storage unit 22, a virtual host state data storage unit 23, a VM state data storage unit 24, an operation list data storage unit 25, and a log data storage unit 26. Moreover, the controller 10 is provided with a control unit 11, an instruction acquisition unit 12, a power management unit 13, a VM management unit 14, and a display unit 15 by reading the program data stored in the memory 20 into the controller 10 and executing it.

The target data storage unit 21 is a storage area within the memory 20 in which target data 21a is stored. The target data 21a contains at least the identifier of the VM run in emulation by the virtual host executed on the computer which the power supply 1 feeds power to. The target data 21a may further contain the identifier of the virtual host. In a case where the power supply system includes multiple power supplies, the target data 21a may contain the information on the virtual hosts, the VMs, and the like of all the power supplies.

Here, the target data 21a may be data in which the identifier of the virtual host executed on the computer is associated with the identifier of the VM run by the virtual host in emulation. The target data 21a has a data structure shown in FIG. 4, for example. In the target data 21a shown in FIG. 4, the identifier of each power supply is associated with the identifiers of its corresponding outlet(s), virtual host(s), and VM(s).

The power supply state data storage unit 22 is a storage area within the memory 20 in which power supply state data 22a is stored. The power supply state data 22a contains data such as current parameters and status of the power supply 1. Moreover, the power supply state data 22a may contain such state data on all the power supplies in the power supply system which the power supply 1 belongs to. For example, in a case of the power supply system shown in FIG. 2, the power supply state data 22a of the first power supply 1a may contain only data on the first power supply 1a, or contain data on the first power supply 1a and on the second power supply 1b. The power supply state data 22a stores therein the latest information on the power supply. The power supply state data 22a is updated every time information on the power supply is updated.

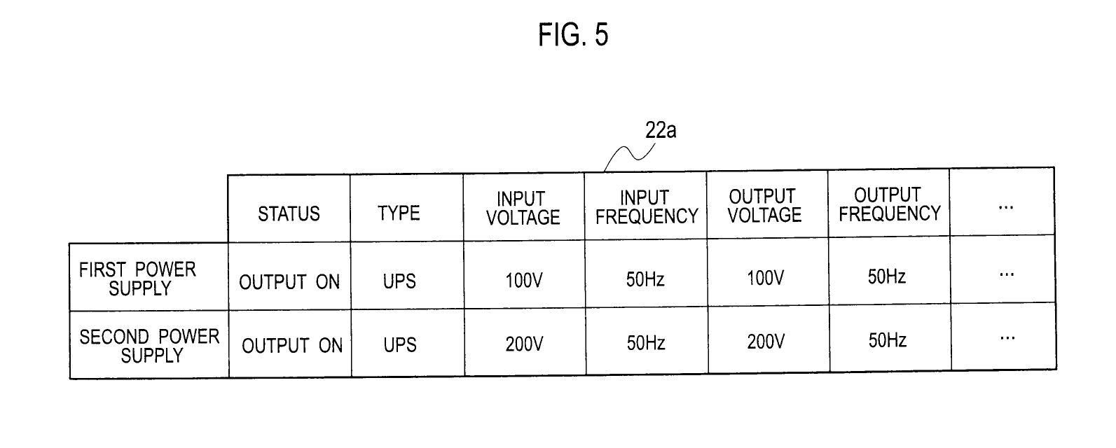

The power supply state data 22a has a data structure shown in FIG. 5, for example. The power supply state data 22a shown in FIG. 5 contains data on the entire power supply system shown in FIG. 2, i.e. the first power supply 1a and the second power supply 1b. In the power supply state data 22a shown in FIG. 5, each power supply identifier is associated with the corresponding power supply's attributes and parameters such as status, type, input voltage, input frequency, output voltage, and output frequency. Here, the “status” of the power supply includes “output on,” “output off,” etc. The status of the power supply may be different depending upon the type of the power supply. The “type” of the power supply is the type of the power supply such as UPS, PDU, or DC power supply, for example. The “input voltage,” “input frequency,” “output voltage,” and “output frequency” of the power supply are data on the running condition of the power supply.

The virtual host state data storage unit 23 is a storage area within the memory 20 in which virtual host state data 23a is stored. The virtual host state data 23a is data in which the identifier of the virtual host is associated with parameters of the virtual host. The virtual host state data 23a may contain such data on only the virtual host which the power supply storing the virtual host state data 23a feeds power to, or on all the virtual hosts in the power supply system. The virtual host state data 23a stores therein current information on the virtual host. The virtual host state data 23a is updated every time information on the virtual host is updated.

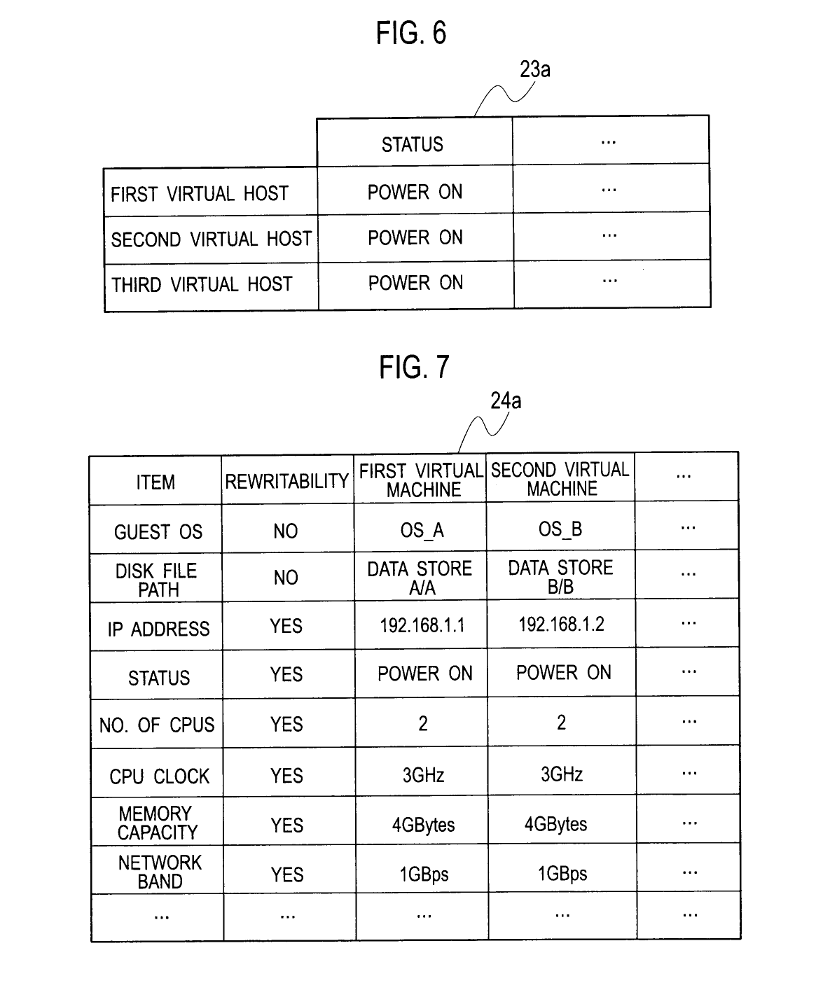

The virtual host state data 23a has a data structure shown in FIG. 6, for example. The virtual host state data 23a shown in FIG. 6 contains data on all the virtual hosts in the power supply system shown in FIG. 2. In the virtual host state data 23a shown in FIG. 6, the identifier of each virtual host is associated with the status and the like of the virtual host. The “status” of the virtual host is the running status of the virtual host such as “power on” and “power off.” In the virtual host state data 23a, the host name, IP address, and the like of each virtual host may also be associated.

The VM state data storage unit 24 is a storage area within the memory 20 in which VM state data 24a is stored. The VM state data 24a is data in which the identifier of the VM is associated with parameters of the VM. The VM state data 24a may contain such data on only the VM which the power supply feeds power to, or on all the VMs in the power supply system. The VM state data 24a stores therein current information on the VM. The VM state data 24a is updated every time information on the VM is updated.

The VM state data 24a has a data structure shown in FIG. 7, for example. The VM state data 24a shown in FIG. 7 contains data on the first VM 3a and the second VM 3b. Morever, the VM state data 24a may contain only data on the VMs run in emulation by the virtual hosts which the first power supply 1a feeds power to, or contain data on all the VMs in the power supply system shown in FIG. 2.

In the VM state data 24a shown in FIG. 7, the identifier of each VM is associated with parameters of the VM such as guest OS, disk file path, IP address, status, the number of CPUs, CPU clock, memory capacity, and network band. In the VM state data 24a shown in FIG. 7, each of these items is associated with an item “rewritability” indicating whether or not the item is rewritable by the power supply 1. In FIG. 7, “YES” in “rewritability” means that the item is rewritable by the power supply 1, whereas “NO” means that the item is not rewritable by the power supply 1. In the example shown in FIG. 7, the power supply 1 cannot rewrite the guest OS and disk file path of any of the VMs but can rewrite the IP address, status, the number of CPUs, CPU clock, memory capacity, network band, and the like of each of the VMs. The “status” of each VM is the running status of the VM such as “power on,” “power on,” and “suspend.” “The number of CPUs,” “CPU clock” “memory capacity,” and “network band” are the parameters of resources allocated to the VM out of the resources of the virtual host running the VM in emulation.

The operation list data storage unit 25 is a storage area within the memory 20 in which operation list data 25a is stored. The operation list data 25a is used to display commands which the power supply 1 can input to an object corresponding to an icon selected by the user from the screen shown in FIG. 3, for example. Here, the object is a component of the power supply system and is in particular any of the power supply, any of the virtual hosts, or any of the VMs.

The operation list data 25a includes power supply operation data 25b, virtual host operation data 25c, and VM operation data 25d. When the user selects the icon of a power supply for example, the display device 60 displays the identifiers of operations contained in the power supply operation data 25b. Similarly, when the user selects the icon of a virtual host, the display device 60 displays the identifiers of operations contained in the virtual host operation data 25c. When the user selects the icon of a VM, the display device 60 displays the identifiers of operations contained in the VM operation data 25d. By selecting one of the identifiers of the operations displayed on the display device 60, the user can input an operation instruction corresponding to that identifier to the controller 10.

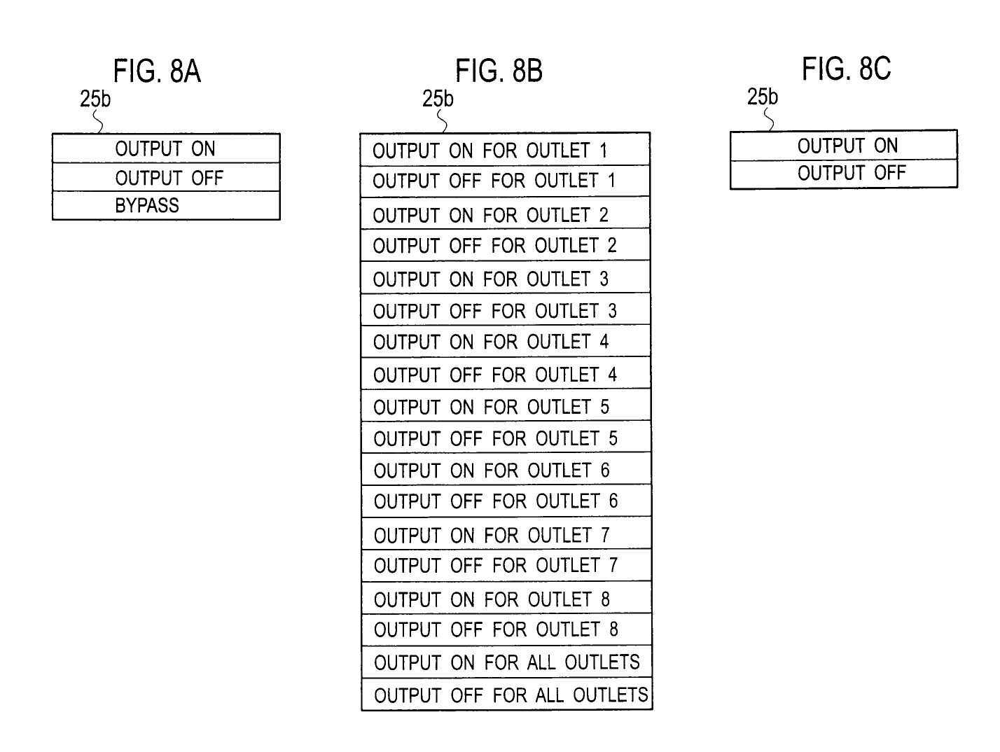

The power supply operation data 25b will be described with reference to FIGS. 8A to 8C. The power supply operation data 25b contains operations related to the output of power by the power supply such as “output on” and “output off.” The user inputs an instruction to the power supply 1 by selecting an operation in the power supply operation data 25b. On the basis of the instruction inputted by the user, the power supply 1 inputs a corresponding instruction to the power supply 1 itself.

Here, the power supply operation data 25b is preferably provided corresponding to the type of the power supply. The power supply operation data 25b shown in FIG. 8A shows a list of operations the user can input to the controller 10 when the power supply is an UPS. The power supply operation data 25b shown in FIG. 8B shows a list of operations the user can input to the controller 10 when the power supply is a PDU. The power supply operation data 25b shown in FIG. 8C shows a list of operations the user can input to the controller 10 when the power supply is a DC power supply.

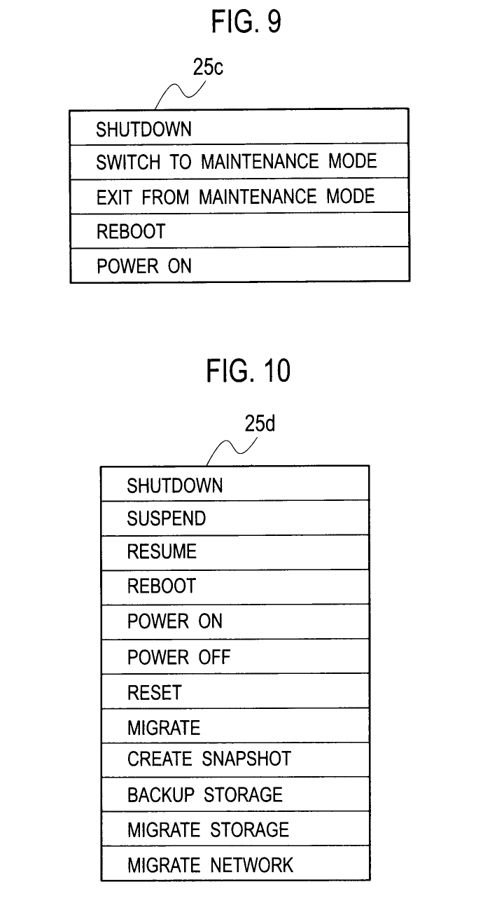

The virtual host operation data 25c will be described with reference to FIG. 9. The virtual host operation data 25c contains operations related to the running of the virtual host such as shutdown, switching to the maintenance mode, exiting from the maintenance mode, reboot, and power on of the virtual host. The user inputs an instruction to the power supply 1 by selecting an operation in the virtual host operation data 25c. On the basis of the instruction inputted by the user, the power supply 1 inputs a corresponding instruction to the virtual host.

The VM operation data 25d will be described with reference to FIG. 10. The VM operation data 25d contains operation instructions for the VM. Specifically, the VM operation data 25d contains operations related to the running of the VM such as shutdown, suspend, resume, reboot, power on, power off, reset, migration, snapshot creation, storage backup, storage migration, and network migration of the VM. The user inputs an instruction to the power supply 1 by selecting an operation in the VM operation data 25d. On the basis of the instruction inputted by the user, the power supply 1 inputs a corresponding instruction to the VM.

The log data storage unit 26 is a storage area within the memory 20 in which log data 26a is stored. The log data 26a is data in which the times of the occurrence of events are associated respectively with the contents of the events that have occurred. The log data 26a may record only events related to the power supply 1, or record events related to the entire power supply system shown in FIG. 2.

The control unit 11 is configured to control processing of the power supply 1. For example, the control unit 11 controls the read and write of data stored in the memory 20. The control unit 11 is also configured to control processing of the instruction acquisition unit 12, the power management unit 13, the VM management unit 14, and the display unit 15. For example, on the basis of an operation instruction inputted by the user through the instruction acquisition unit 12, the control unit 11 reads data from the memory 20 or inputs instructions to the power management unit 13, the VM management unit 14, and the display unit 15 for their processing.

For example, in a case where the operation instruction from the user is an instruction to display the state of a power supply, the control unit 11 reads the power supply state data 22a from the memory 20 and displays the state such as the parameters of the power supply on the display device 60. Similarly, upon input an instruction to display the state of a virtual host or a VM, the control unit 11 reads the virtual host state data 23a or the VM state data 24a from the memory 20 and displays the state such as the parameters of the virtual host or the VM on the display device 60.

Moreover, in a case where the operation instruction from the user is to change a parameter of a VM, the control unit 11 stores the changed parameter in the VM state data 24a. In a case where the operation instruction from the user is to change a parameter of a virtual host, the control unit 11 stores the changed parameter in the virtual host state data 23a.

Furthermore, upon input of an instruction to migrate a VM, the control unit 11 deletes, from the target data 21a, the data in which the migration target VM and the virtual host running the migration target VM in emulation are associated with each other, and inserts data, into the target data, data in which the VM and the migration destination virtual host are associated with each other.

For instance, in the example shown in FIG. 2, when transmitting an instruction to the first VM 3a, the VM management unit 14 may transmit the instruction to the first VM 3a or to the first virtual host computer 2a running the first VM 3a in emulation. For instance, in the example shown in FIG. 2, in the migration of the fourth VM 3d to the first virtual host computer 2a, the control unit 11 deletes, from the target data storage unit 21, the data in which the fourth VM 3d and the third virtual host computer 2c are associated with each other, and inserts data in which the fourth VM 3d and the first virtual host computer 2a are associated with each other.

The control unit 11 is also configured to acquire the result of the execution of an instruction inputted from the power management unit 13 or the VM management unit 14. The control unit 11 creates a record in which the time of the occurrence of the corresponding event and the content of the event that has occurred are associated with each other, and inserts the record into the log data 26a.

The instruction acquisition unit 12 is configured to input, to the control unit 11, an instruction inputted by the user through an operation of the input unit 30. In this event, the instruction acquisition unit 12 acquires the inputted instruction in association with the identifier of the instruction target of the user and inputs them to the control unit 11. Here, the instruction target is a component of the power supply system shown in FIG. 2 and is any of the power supplies, any of the virtual hosts, or any of the VMs. For example, when the user selects an operation instruction for a virtual host displayed on the display device 60 through the input unit 30, the instruction acquisition unit 12 acquires the selected operation instruction and the identifier of the virtual host corresponding to this operation instruction and inputs them to the control unit 11. Moreover, when the user selects an operation instruction for a VM displayed on the display device 60 through the input unit 30, the instruction acquisition unit 12 acquires the selected operation instruction and the identifier of the VM corresponding to this operation instruction and inputs them to the control unit 11.

The power management unit 13 is configured to control the power feed unit 40 on the basis of an instruction from the control unit 11 and thereby control the feed of power to the virtual host computer. For example, when the user inputs an instruction to shut down the virtual host computer 2 through the input unit 30, the instruction is inputted to the power management unit 13 through the instruction acquisition unit 12 and the control unit 11. The power management unit 13 then shuts off the power feed to the virtual host computer 2 and controls shutdown processing of the power feed unit 40.

The VM management unit 14 is configured to control the virtual host computer 2 and the virtual system such as the VM 3 run by the virtual host computer 2 in emulation. For example, the VM management unit 14 inputs an operation instruction for the VM 3 to the VM 3 on the basis of acquisition by the instruction acquisition unit 12 and an instruction from the control unit 11. Moreover, the VM management unit 14 inputs an operation instruction to the virtual host corresponding to this operation instruction on the basis of acquisition by the instruction acquisition unit 12 and an instruction from the control unit 11.

Meanwhile, in a case where the operation instruction is an instruction to migrate a VM from the virtual host running the VM in emulation, to a different virtual host, the VM management unit 14 inputs an instruction to migrate the VM to the different virtual host to the virtual host running the VM in emulation. For instance, in the example shown in FIG. 2, in the migration of the fourth VM 3d to the firth virtual host computer 2a, the VM management unit 14 inputs an instruction to transmit the fourth VM 3d to the first virtual host computer 2a to the third virtual host computer 2c currently running the fourth VM 3d in emulation.

Here, the VM management unit 14 can input an instruction for a VM to the VM or to the virtual host running the VM in emulation. For instance, in the example shown in FIG. 2, when transmitting an instruction to the first VM 3a, the VM management unit 14 may transmit the instruction to the first VM 3a or to the first virtual host computer 2a running the first VM 3a in emulation. In a case of transmitting an instruction to the first virtual host computer 2a, the first virtual host computer 2a inputs the transmitted instruction to the first VM 3a.

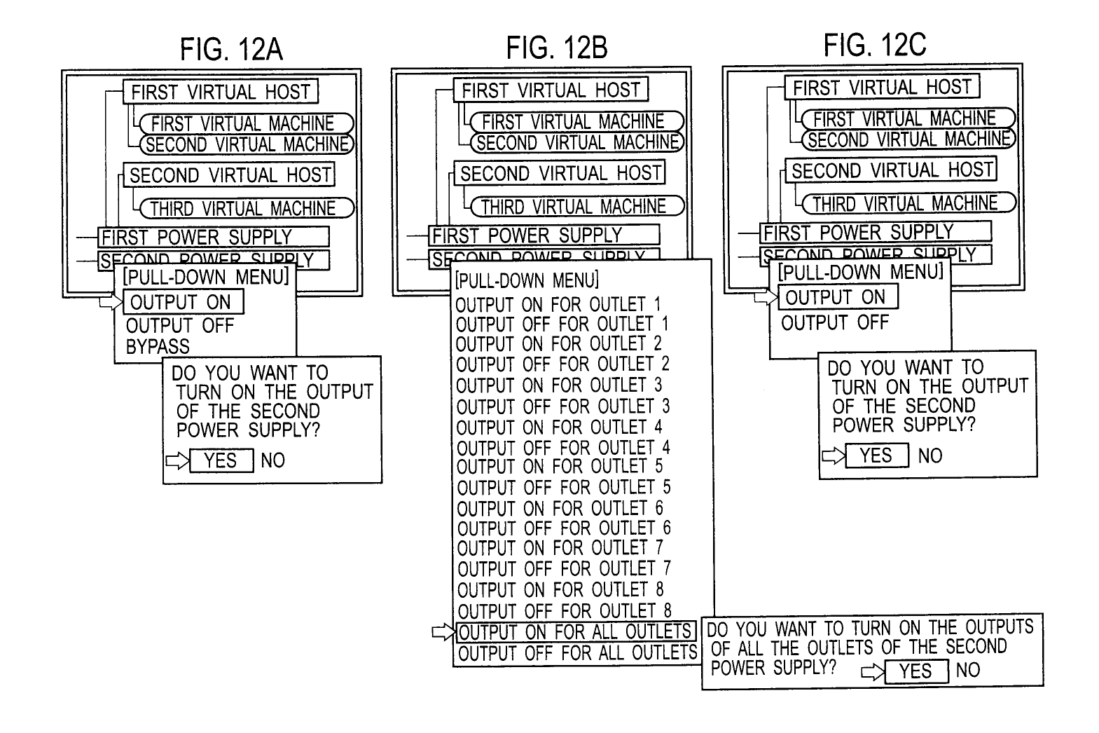

The display unit 15 is a unit configured to display a screen on the display device 60 on the basis of an instruction from the control unit 11. The display unit 15 displays any of the screens shown in FIGS. 12A to 17 mentioned later on the display device 60, for example.

In order to display the power supply system shown in FIG. 2 in the form of a tree structure, the display unit 15 displays the identifier of each virtual host and the identifier of its VM(s) in association with each other as shown in FIG. 3 on the basis of the target data 21a. Moreover, the display unit 15 displays, on the display device 60, the identifier of a virtual host in association with the operation instructions for the virtual host contained in the virtual host operation data 25c in the operation list data storage unit 25. The display unit 15 displays, on the display device 60, the identifier of a VM in association with the operation instructions for the VM contained in the VM operation data 25d in the operation list data storage unit 25.

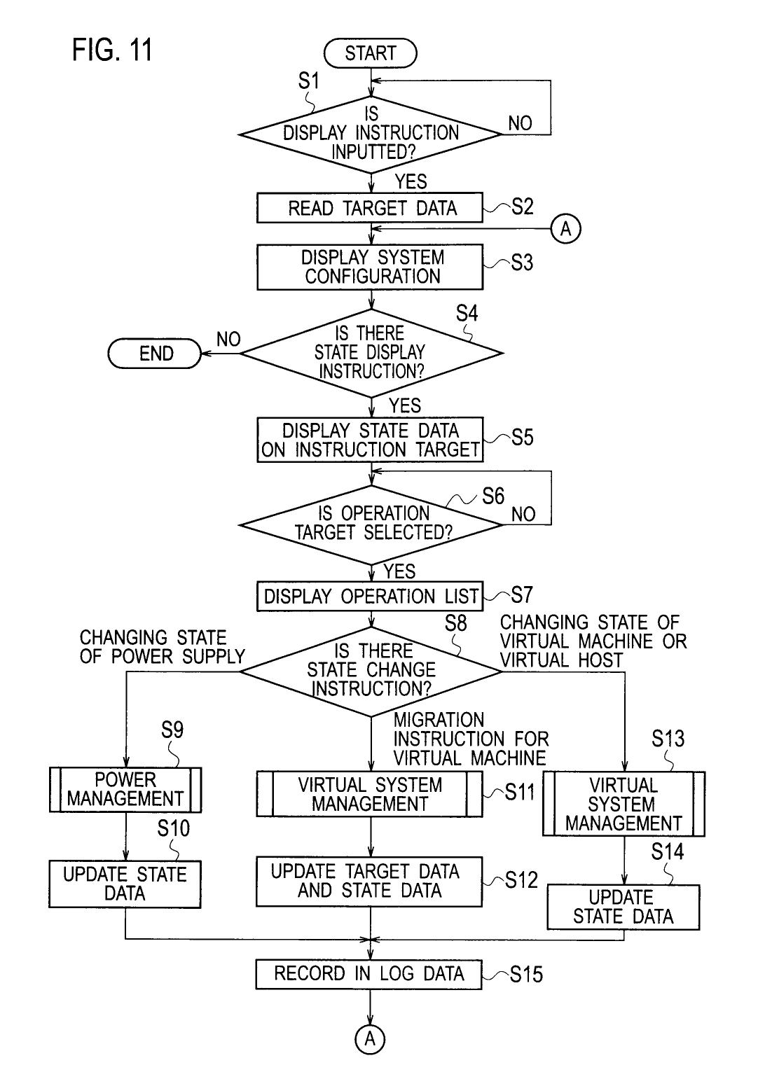

Processing of the control unit 11 will be described with reference to FIG. 11. In FIG. 11, described is processing in a case where the display device 60 is caused to display the identifier of each object of the power supply system shown in FIG. 2, then an instruction to display the state of each object is inputted, and thereafter an instruction to perform an operation to change the state of a given object is inputted.

First, when a display instruction is inputted in step S1, the control unit 11 reads the target data 21a from the memory 20 in step S2. In step S3, the control unit 11 displays a configuration diagram of the objects as shown in FIG. 2 on the display device 60 on the basis of the target data 21a read in step S2. The display instruction in step S1 can be inputted in various manners; the display instruction may be inputted through the input unit 30 of the power supply 1, inputted upon booting the power supply 1, or inputted in some other manner.

Next, when the user inputs a state display instruction in step S4, the control unit 11 displays state data on the instruction target object on the display device 60 in step S5. For example, when an instruction to display state data on a given power supply is inputted, the control unit 11 acquires data on the state of the power supply from the power supply state data 22a and displays the state data on the power supply on the display device 60. Similarly, when an instruction to display state data on a given virtual host is inputted, the control unit 11 acquires data on the state of the virtual host from the virtual host state data 23a and displays the state data on the virtual host on the display device 60. When an instruction to display state data on a given VM is inputted, the control unit 11 acquires data on the state of the VM from the VM state data 24a and displays the state data on the VM on the display device 60.

When the user selects an operation target in step S6, the control unit 11 displays an operation list for the operation target on the display device 60 in step S7. For example, in a case where the operation target is a given power supply, the control unit 11 reads the power supply operation data 25b from the memory and displays the operation list for the power supply contained in the power supply operation data 25b on the display device 60. Here, the power supply operation data 25b is different depending upon the type of the power supply as shown in FIGS. 8A to 8C; therefore, the control unit 11 displays the operations corresponding to the type of the operation target power supply. In a case where the operation target is a given virtual host, the control unit 11 reads the virtual host operation data 25c from the memory and displays the operation list for the virtual host contained in the virtual host operation data 25c on the display device 60. In a case where the operation target is a given VM, the control unit 11 reads the VM operation data 25d from the memory and displays the operation list for the VM contained in the VM operation data 25d on the display device 60.

When the user inputs a state change instruction in step S8, the control unit 11 selects processing in accordance with the content of the change.

The control unit 11 proceeds to step S9 when the inputted state change instruction is an instruction to change the state of a power supply. In step S9, on the basis of the inputted state change instruction, the control unit 11 inputs an instruction to change the state of the change target power supply to the power management unit 13. On the basis of the inputted instruction, the power management unit 13 inputs a corresponding instruction to the power feed unit 40 to thereby change the state of the power supply. After completing the state change, the control unit 11 updates the power supply state data 22a in step S10 on the basis of the change made in step S9.

The control unit 11 proceeds to step S11 when the inputted state change instruction is an instruction to migrate a VM. In step S11, on the basis of the inputted migration instruction, the control unit 11 inputs an instruction to migrate the migration target VM to the migration destination virtual host to the VM management unit 14. On the basis of the inputted instruction, the VM management unit 14 inputs a corresponding instruction to the communication control device 50 to thereby migrate the migration target VM. After completing the migration of the VM, the control unit 11 updates the target data 21a in step S12 on the basis of the migration performed in step S11. The control unit 11 also updates the VM state data 24a in a case where the migration causes change in the resources allocated to the migration target VM.

The control unit 11 proceeds to step S13 when the inputted state change instruction is an instruction to change the state of a VM or virtual host. In step S13, on the basis of the inputted state change instruction, the control unit 11 inputs an instruction to change the state of the change target VM or virtual host to the VM management unit 14. On the basis of the inputted instruction, the VM management unit 14 inputs a corresponding instruction to the communication control device 50 to thereby change the state of the VM or virtual host. After completing the state change, the control unit 11 updates the virtual host state data 23a or VM state data 24a in step S14 on the basis of the change made in step S13.

After completing the data update in step S10, S12, or S14, the control unit 11 records information indicating that the instruction has been processed in the log data 26a in step S15. After recording the information in the log data, the control unit 11 displays the system configuration on the display device 60 in step S3 on the basis of the updated target data 21a.

Next, examples of a screen displayed by the display device 60 of the power supply 1 of the embodiment will be described with reference to FIGS. 12A to 17.

First, screens for inputting an operation instruction to a power supply will be described with reference to FIGS. 12A to 12C. FIG. 12A describes a screen in a case where the power supply is an UPS. In a screen displaying the configuration of the power supply system shown in FIG. 2, selecting the second power supply 1b displays a list of operations inputtable to the second power supply 1b in the form of a pull-down menu as shown in FIG. 12A. Here, the displayed list of operations corresponds to the power supply operation data 25b on the power supply (UPS) described with reference to FIG. 8A. When the user selects for example the “OUTPUT ON” operation from the list of power supply operations displayed on the display device 60, the display device 60 displays a confirmation message confirming whether or not to turn on the output of the second power supply 1b. Selecting “YES” in this confirmation message inputs an instruction to turn on the output of the second power supply 1b to the control unit 11 through the instruction acquisition unit 12. On the basis of the instruction inputted by the instruction acquisition unit 12, the control unit 11 inputs a corresponding instruction to the power feed unit 40 through the power management unit 13. Meanwhile, FIG. 12B shows an example menu in a case where the power supply is a PDU, and this menu corresponds to the power supply operation data 25b on the power supply (PDU) described with reference to FIG. 8B. Moreover, FIG. 12C shows an example menu in a case where the power supply is a DC power supply, and this menu corresponds to the power supply operation data 25b on the power supply (DC power supply) described with reference to FIG. 8C.

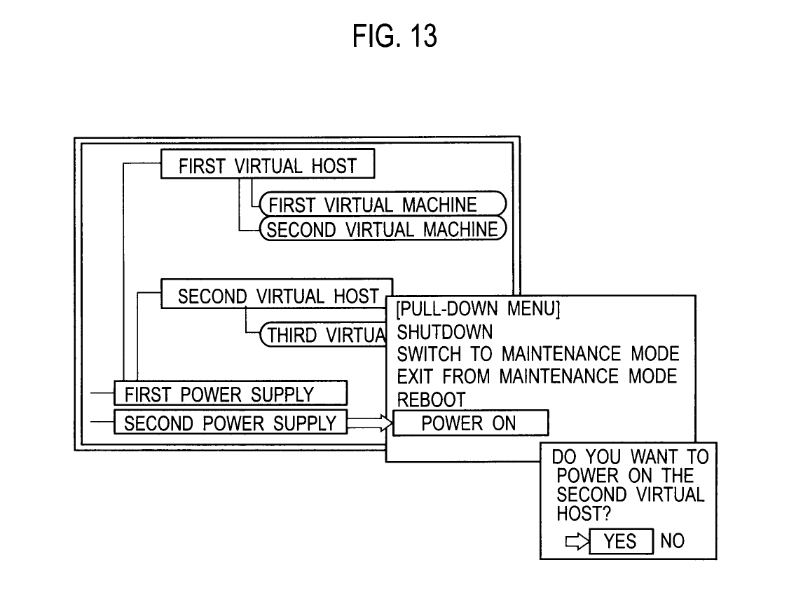

A screen for inputting an operation instruction to a virtual host will be described with reference to FIG. 13. In a screen displaying the configuration of the power supply system shown in FIG. 2, selecting the second virtual host 2b by right-clicking the mouse or doing the like displays a list of operations inputtable to the second virtual host 2b in the form of a pull-down menu. Here, the displayed list of operations corresponds to the virtual host operation data 25c described with reference to FIG. 9. When the user selects for example the “POWER ON” operation from the list of virtual host operations displayed on the display device 60, the display device 60 displays a confirmation message confirming whether or not to power on the second virtual host 2b. Selecting “YES” in this confirmation message inputs an instruction to power on the second virtual host 2b to the control unit 11 through the instruction acquisition unit 12. On the basis of the instruction inputted by the instruction acquisition unit 12, the control unit 11 inputs a corresponding instruction to the VM management unit 14.

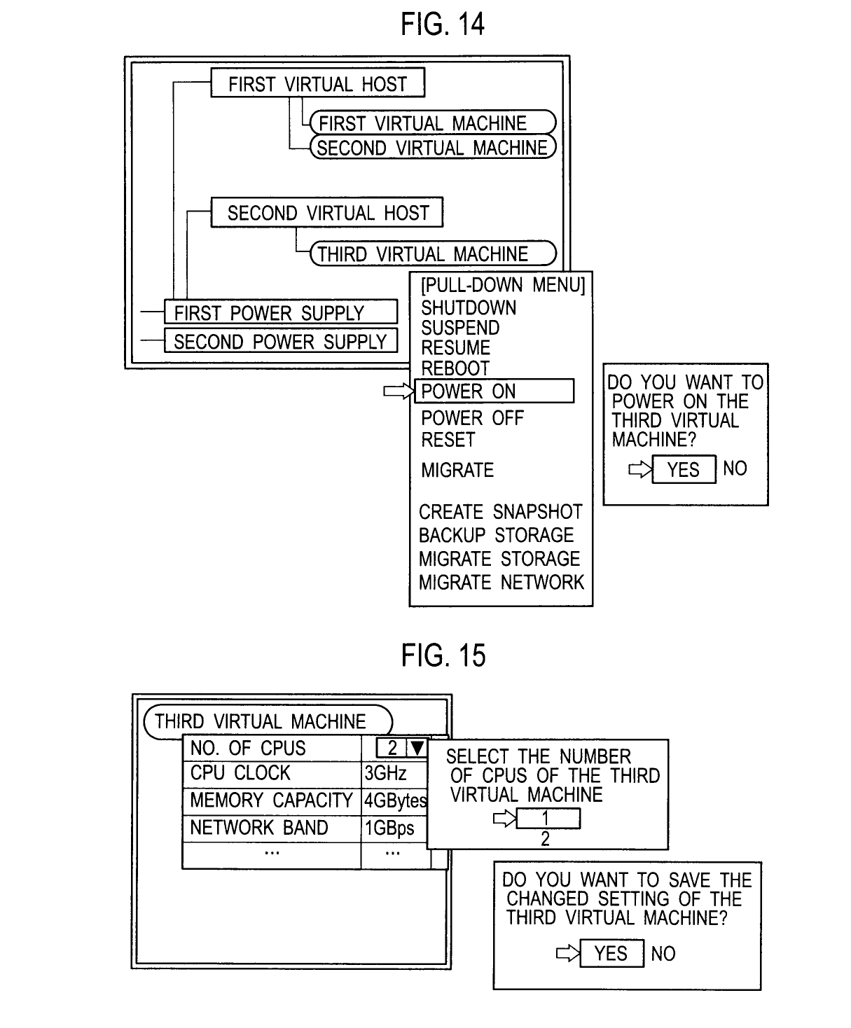

A screen for inputting an operation instruction to a VM will be described with reference to FIG. 14. In a screen displaying the configuration of the power supply system shown in FIG. 2, selecting the third VM 3c by right-clicking the mouse or doing the like displays a list of operations inputtable to the third VM 3c in the form of a pull-down menu. Here, the displayed list of operations corresponds to the VM operation data 25d described with reference to FIG. 10. When the user selects for example the “POWER ON” operation from the list of VM operations displayed on the display device 60, the display device 60 displays a confirmation message confirming whether or not to power on the third VM 3c. Selecting “YES” in this confirmation message inputs an instruction to power on the third VM 3c to the control unit 11 through the instruction acquisition unit 12. On the basis of the instruction inputted by the instruction acquisition unit 12, the control unit 11 inputs a corresponding instruction to the VM management unit 14.

A screen for displaying the state of a VM and for inputting an instruction to change a parameter thereof will be described with reference to FIG. 15. In a screen displaying the configuration of the power supply system shown in FIG. 2, selecting the third VM 3c by double-clicking the mouse or doing the like displays a screen as shown in FIG. 15. FIG. 15 shows a screen displaying a list of parameters of the third VM 3c. Each parameter displayed in FIG. 15 corresponds to the VM state data on the third VM 3c within the VM state data 24a described with reference to FIG. 7. Here, “2” is displayed as the number of CPUs of the third VM. When the user selects an item having “YES” in its rewritability field in FIG. 7 from among the parameters displayed in FIG. 15, a mode permitting rewrite of the selected item is set. For example, as shown in FIG. 15, selecting “NO. OF CPUS” displays a screen for selecting a number to which the number of CPUs is changed. Here, when the user selects “1,” the display device 60 displays a confirmation message confirming whether or not to change the number of CPUs of the third VM 3c to “1.” Selecting “YES” in this confirmation message inputs an instruction to change the number of CPUs of the third VM 3c from “2” to “1” to the control unit 11 through the instruction acquisition unit 12. On the basis of the instruction inputted by the instruction acquisition unit 12, the control unit 11 inputs a corresponding instruction to the VM management unit 14.

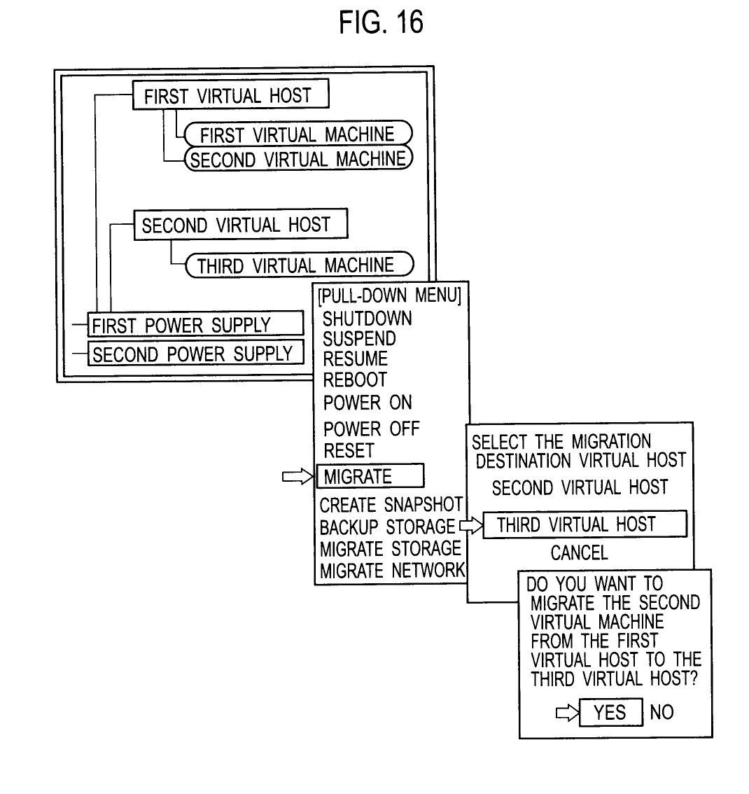

A screen for inputting an operation instruction to a VM will be described with reference to FIG. 16. In a screen displaying the configuration of the power supply system shown in FIG. 2, selecting the second VM 3b by right-clicking the mouse or doing the like displays a list of operations inputtable to the second VM 3b in the form of a pull-down menu. Here, the displayed list of operations corresponds to the VM operation data 25d described with reference to FIG. 10. When the user selects for example the “MIGRATION” operation from the list of VM operations displayed on the display device 60, the control unit 11 displays a screen for designating the migration destination virtual host. For instance, in the example shown in FIG. 2, the migration target, or the second VM 3b, is run by the first virtual host 2a in emulation; thus, the control unit 11 refers to the target data 21a and displays, out of all the virtual hosts contained in the target data 21a, the virtual hosts other than the virtual host running the migration target in emulation, or the second VM 3b, as migration destination candidates. Specifically, the control unit 11 displays the virtual hosts other than the first virtual host 2a, i.e. the second virtual host 2b and the third virtual host 2c as migration destination candidates. When the user designates for example the third virtual host 2c as the migration destination, the display device 60 displays a confirmation message confirming whether or not to migrate the second VM 3b to the third virtual host 2c. Selecting “YES” in this confirmation message inputs an instruction to migrate the second VM 3b to the third virtual host 2c to the control unit 11 through the instruction acquisition unit 12. On the basis of the instruction inputted by the instruction acquisition unit 12, the control unit 11 inputs a corresponding instruction to the VM management unit 14. After the execution of the instruction, the control unit 11 updates the log data 26a and also updates the target data 21a and the VM state data 24a.

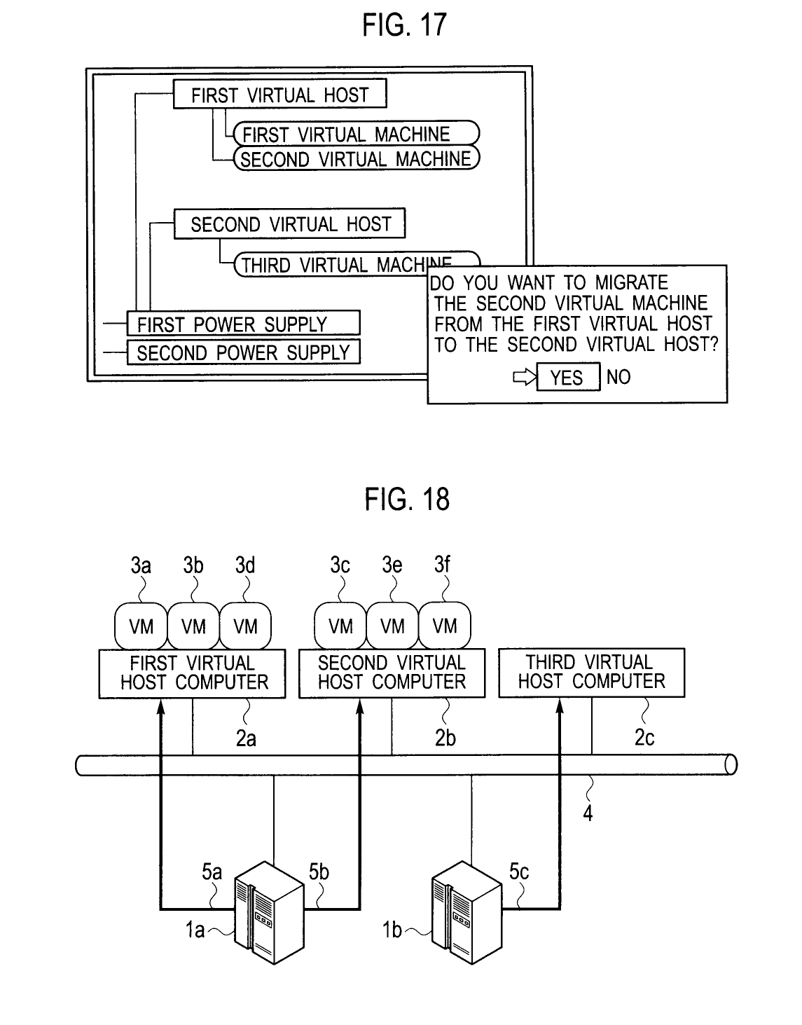

FIG. 16 has been used to describe the case where migration is selected from the operation list displayed regarding a VM. A case where a migration instruction is inputted through drag-and-drop will be now described with reference to FIG. 17. The user can specify the migration target VM and the migration destination virtual host by selecting the icon of a desired VM displayed on the display device 60 and dragging and dropping the icon onto the icon of the migration destination virtual host of the VM, through the input unit 30. In the case of FIG. 17 too, when the user designates for example the second virtual host 2b as the migration destination of the second VM 3b, the display device 60 displays the confirmation message confirming whether or not to migrate the second VM 3b to the second virtual host 2b.

As described by using the screens shown in FIGS. 16 and 17, when the user inputs a migration instruction for a VM, the instruction is inputted to the corresponding virtual host computer 2 or VM 3 through the VM management unit 14 and the communication control device 50, and the migration of the VM is executed. A system configuration after such VM migration will be described with reference to FIG. 18.

A power supply system in FIG. 18 differs from the power supply system described with reference to FIG. 2 in that the fourth VM 3d, the fifth VM 3e, and the sixth VM 3f run by the third virtual host computer 2c in emulation are migrated from the third virtual host computer 2c to different virtual host computers. Specifically, the fourth VM 3d is migrated to the first virtual host computer 2a whereas the fifth VM 3e and the sixth VM 3f are migrated to the second virtual host computer 2b.

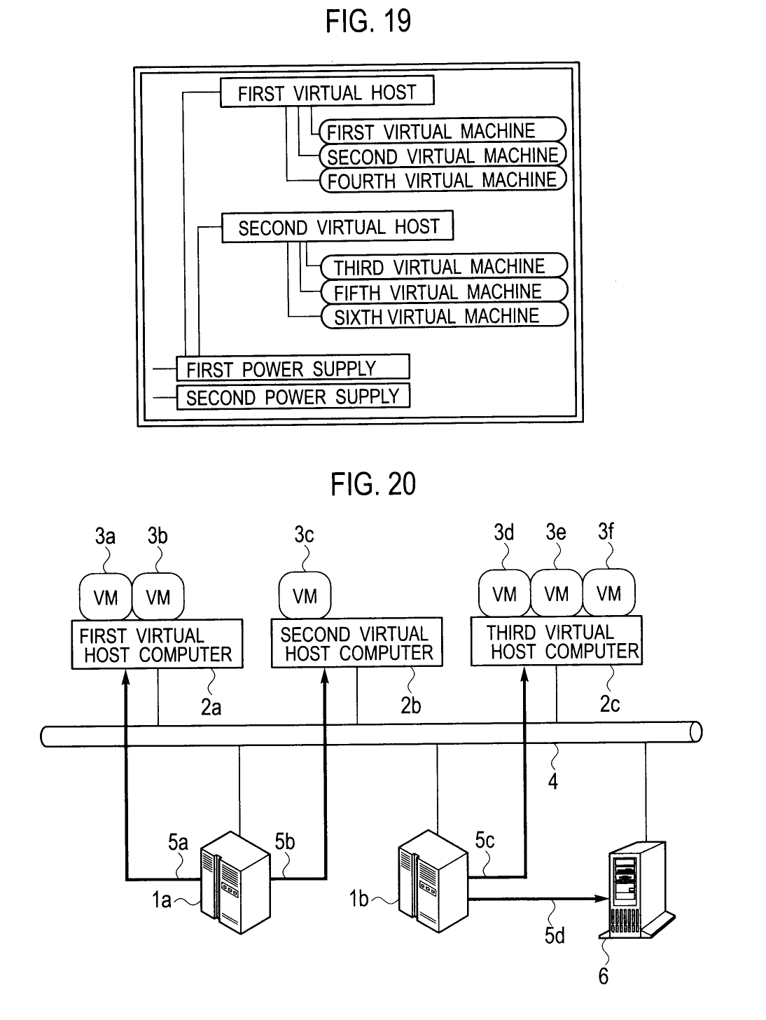

As the power supply system shown in FIG. 18, the display unit 15 displays a screen as shown in FIG. 19 on the display device 60. In the screen shown in FIG. 19, the identifier of the first power supply 1a is associated with the identifier of each of the first virtual host 2a and the second virtual host 2b. The identifier of the first virtual host 2a is associated with the identifier of each of the first VM 3a, the second VM 3b, and the fourth VM 3d. The identifier of the second virtual host 2b is associated with the identifier of each of the third VM 3c, the fifth VM 3e, and the sixth VM 3f. Meanwhile, although the identifier of the second power supply 1b is displayed alone in the example shown in FIG. 19, selecting the second power supply 1b displays the information on the virtual host and VM connected to the second power supply 1b. Specifically, the identifier of the second power supply 1b is associated with the identifier of the third virtual host 2c. As shown in FIG. 18, there is no VM run by the third virtual host 2c in emulation. Thus, the identifier of the third virtual host 2c displayed on the display device 60 is not associated with the identifier of any VM.

As described, no VM is run by the third virtual host 2c in emulation in the power supply system shown in FIG. 18. Therefore, the second power supply 1b can be shut down itself after shutting down the third virtual host computer 2c. Accordingly, the energy for the third virtual host computer 2c and the second power supply 1b can be saved.

The configuration as described above is preferable for example for a system running in a mixture of: a period during which a large amount of data is processed thereby requiring many resources; and a period during which a small amount of data is processed thereby allowing the system to run with only a few resources. For example, in a case where a large amount of data needs to be processed during the day time, many virtual host computers and power supply are caused to run as shown in FIG. 2 in accordance with a predetermined schedule. On the other hand, during the night time during which the amount of data to be processed is small, the least virtual host computers and power supply are caused to run as shown in FIG. 18 in accordance with a predetermined schedule. The configuration is also preferable for a system for reserving tickets or the like in which the amount of data to be processed increases randomly. For example, in a case of a computer system configured to start accepting ticket orders at a predetermined time, many computers may be caused to run only for a predetermined period from the time at which the system starts accepting ticket orders, whereas the number of running computers may be reduced during the other period.

In the embodiment of the present invention, each power supply is given functions that are given to a virtualization management server, and hence the power supply can manage virtual systems. Accordingly, the power supply of the embodiment of the present invention can synchronize the power management and the virtualization management with each other. This makes it possible to control migration of a VM, shutdown of a virtual host computer, migration of a power supply, and the like as a series of operations. Consequently, the power feed and the virtualization management are synchronized with each other, and thus the reliability of the whole system can be improved.

Further, the power supply of the embodiment of the present invention can issue various instructions such as changing a parameter to a VM and a virtual host. In the conventional case, a management terminal configured to manage VMs and virtual hosts manages or controls the VMs and virtual hosts, while power supplies manages the power supplies of the virtual hosts. In contrast, the power supply of the embodiment of the present invention can collectively manage the power supplies, the VMs and the virtual hosts. Accordingly, the power supply of the embodiment of the present invention can achieve cooperation among the power supplies, the VMs, and the virtual hosts and therefore assist smooth system operation.

By causing the power supply to control the virtualization management of the virtual systems as described, the reliability of the whole power supply system is improved.

### Modification

The description has been given of the case where the power supply 1 of the embodiment of the present invention described above includes the input unit 30 and the display device 60. A modification will be now described in which the power supply 1 does not include the input unit 30 and the display device 60 and, instead, uses an input unit and a display device of a separate hardware computer to input and output information to and from the power supply 1.

A power supply system of a modification shown in FIG. 20 differs from the power supply system of the embodiment of the present invention shown in FIG. 2 in that the power supply system of the modification includes a management terminal 6. The management terminal 6 is implemented by installing a predetermined management program in a general computer and executing it. In addition, the second power supply 1b includes a fourth outlet 5d and feeds power to the management terminal 6 through the fourth outlet 5d.

The management terminal 6 includes an input unit such as a mouse and a keyboard and a display device such as a liquid crystal display. The display device of the management terminal 6 is configured to display the screens described with reference to FIG. 3 and other drawings, as well as some other figures.

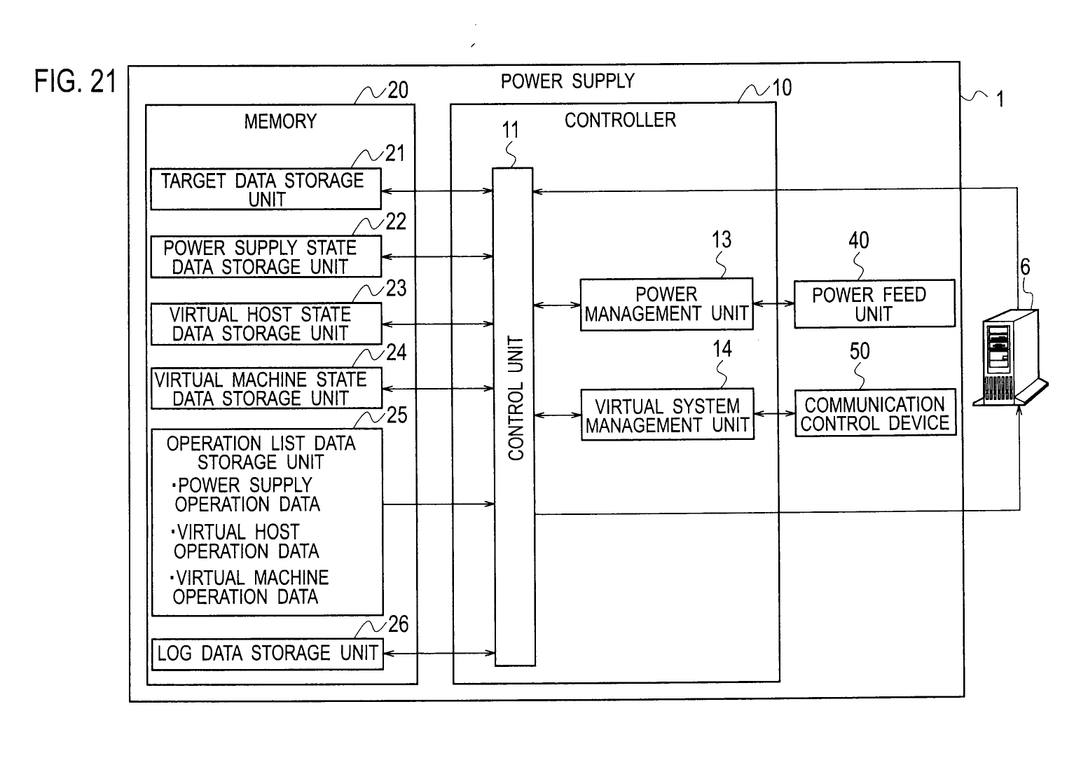

As shown in FIG. 21, the user inputs an instruction to the management terminal 6 while referring to a screen displayed on the display device of the management terminal 6 by operating the input unit of the management terminal 6. The central processing unit of the management terminal 6 inputs the instruction inputted by the user through an operation of the input unit, to the control unit 11 of the power supply 1. In this event, the central processing unit of the management terminal 6 acquires the inputted instruction in association with the identifier of the instruction target of the user and inputs them to the control unit 11 of the power supply 1.

On the basis of the inputted instruction, the control unit 11 of the power supply 1 performs processing in the manner described in the embodiment of the present invention. Moreover, the control unit 11 of the power supply 1 inputs an instruction to the central processing unit of the management terminal 6 to display a screen on the display device thereof in the manner described in the embodiment of the present invention.

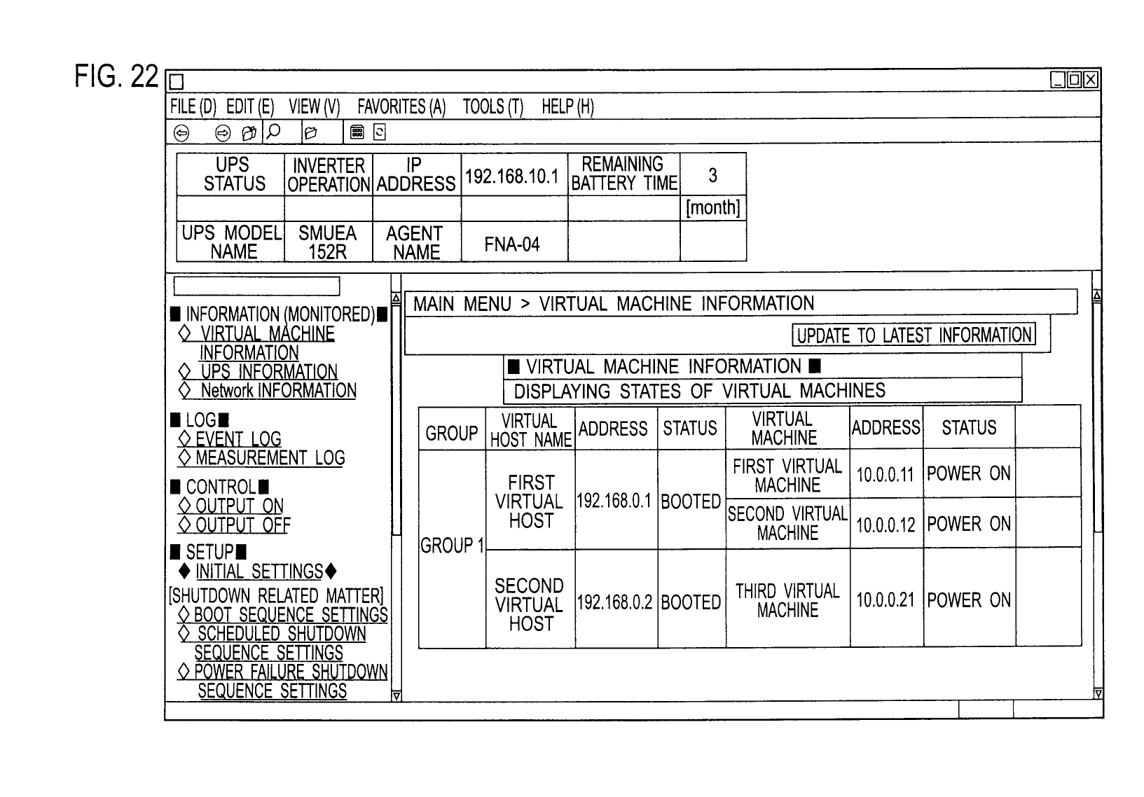

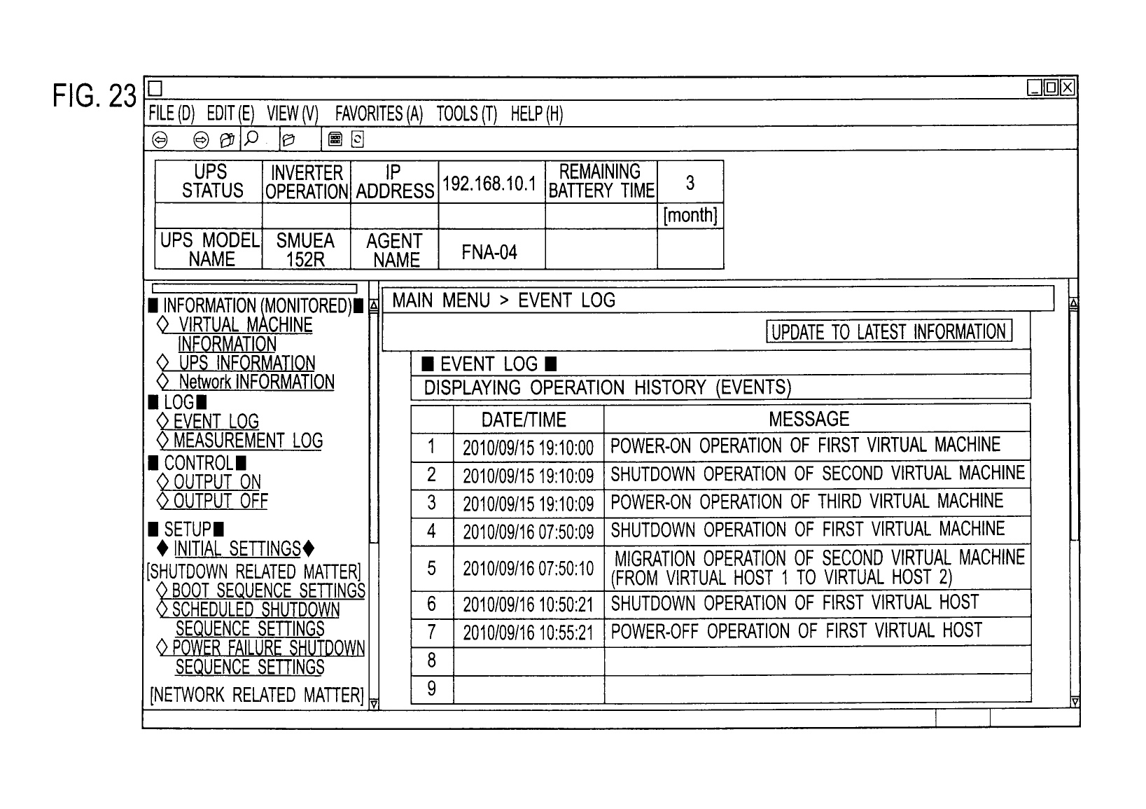

Now, examples of a screen displayed on the display device of the management terminal 6 will be described with reference to FIGS. 22 and 23. FIG. 22 is a screen displaying information on VMs. In the example shown in FIG. 22, the screen is displayed on a browser. Moreover, the screen shown in FIG. 22 includes links of “EVENT LOG,” “MEASUREMENT LOG,” and the like. When the user clicks the “EVENT LOG” link, the display device displays the log data 26a in the power supply 1 as shown in FIG. 23.

The screens shown in FIGS. 22 and 23 contain larger amounts of information than those of the screens described with reference to FIGS. 12A to 17 and other drawings. Moreover, since various links are provided, the user can easily input an instruction to migrate a VM within the power supply system, an instruction to change a parameter of a component, and the like, to the power supply 1 through the management terminal 6.

### Other Embodiments

Although the present invention has been described using the foregoing embodiment and modification, it should not be understood that the statement and drawings constituting part of this disclosure limit this invention. Various alternative embodiments, examples, and operation techniques become apparent to those skilled in the art from this disclosure.

The present invention includes various embodiments and the like that are not described herein, as a matter of course. Therefore, the technical scope of the present invention shall be determined solely by the specified matters in the invention according to the claims that are appropriate from the above description.

What is claimed is:

1. A power supply for feeding power to a computer, comprising:
an instruction acquisition unit configured to acquire an identifier of a virtual machine and an instruction for the virtual machine, the virtual machine being run in emulation by a virtual host executed on the computer; and
a virtual machine management unit configured to input an operation instruction for the virtual machine to the virtual machine on the basis of the acquisition by the instruction acquisition unit.

2. The power supply according to claim 1, further comprising:
an operation list data storage unit configured to store operation list data containing the operation instruction for the virtual machine; and
a display unit configured to display, on a display device, the identifier of the virtual machine and the operation instruction for the virtual machine in the operation list data in association with each other, wherein
when a user selects the operation instruction for the virtual machine displayed on the display device through an input unit, the instruction acquisition unit acquires the selected operation instruction and the identifier of the virtual machine corresponding to the operation instruction, and
the virtual machine management unit inputs the selected operation instruction to the virtual machine corresponding to the operation instruction on the basis of the acquisition by the instruction acquisition unit.

3. The power supply according to claim 1, further comprising:
a virtual machine state data storage unit configured to store virtual machine state data in which the identifier of the virtual machine and a parameter of the virtual machine are associated with each other; and
a control unit configured to store, in a case where the operation instruction is to change the parameter of the virtual machine, the changed parameter in the virtual machine state data.

4. The power supply according to claim 2, wherein
the operation list data further contains an operation instruction for the virtual host,
the display unit further displays, on the display device, an identifier of the virtual host and the operation instruction for the virtual host in the operation list data in association with each other,
when the user selects the operation instruction for the virtual host displayed on the display device through the input unit, the instruction acquisition unit acquires the selected operation instruction and the identifier of the virtual host corresponding to the operation instruction, and
the virtual machine management unit inputs the selected operation instruction to the virtual host corresponding to the operation instruction on the basis of the acquisition by the instruction acquisition unit.

5. The power supply according to claim 4, further comprising a virtual host state data storage unit configured to store virtual host state data in which the identifier of the virtual host and a parameter of the virtual host are associated with each other, wherein
in a case where the operation instruction is to change the parameter of the virtual host, the control unit stores the changed parameter in the virtual host state data.

6. The power supply according to claim 4, further comprising a target data storage unit configured to store target data in which the identifier of the virtual host and the identifier of the virtual machine run in emulation by the virtual host are associated with each other, wherein
the display unit displays the identifier of the virtual host and the identifier of the virtual machine in association with each other on the basis of the target data.

7. The power supply according to claim 6, wherein
in a case where the operation instruction is an instruction to migrate the virtual machine from the virtual host running the virtual machine in emulation to a different virtual host, the virtual machine management unit inputs the instruction to migrate the virtual machine to the different virtual host to the virtual host running the virtual machine in emulation, and
the control unit deletes, from the target data, data in which the virtual machine and the virtual host running the virtual machine in emulation are associated with each other, and inserts, into the target data, data in which the virtual machine and the different virtual host are associated with each other.

8. A control method of a power supply for feeding power to a computer, comprising the steps of:
acquiring an identifier of a virtual machine and an instruction for the virtual machine, the virtual machine being run in emulation by a virtual host executed on the computer; and
inputting an operation instruction for the virtual machine to the virtual machine.

9. The control method according to claim 8, further comprising the steps of:
displaying, on a display device, the identifier of the virtual machine and the operation instruction for the virtual machine in association with each other, the operation instruction for the virtual machine being contained in operation list data; and
when a user selects the operation instruction for the virtual machine displayed on the display device through an input unit, acquiring the selected operation instruction and the identifier of the virtual machine corresponding to the operation instruction; and
inputting the selected operation instruction to the virtual machine corresponding to the operation instruction.

10. The control method according to claim 9, further comprising the step of, in a case where the operation instruction is to change a parameter of the virtual machine, storing the changed parameter in virtual machine state data in which the identifier of the virtual machine and the parameter of the virtual machine are associated with each other.

11. The control method according to claim 9, wherein
the operation list data further contains an operation instruction for the virtual host, and
the control method further comprises the steps of:
displaying, on the display device, an identifier of the virtual host and the operation instruction for the virtual host in the operation list data in association with each other;
when the user selects the operation instruction for the virtual host displayed on the display device through the input unit, acquiring the selected operation instruction and the identifier of the virtual host corresponding to the operation instruction; and
inputting the selected operation instruction to the virtual host corresponding to the operation instruction.

12. The control method according to claim 11, further comprising the step of, in a case where the operation instruction is to change a parameter of the virtual host, storing the changed parameter in virtual host state data in which the identifier of the virtual host and the parameter of the virtual host are associated with each other.

13. The control method according to claim 11, further comprising the step of displaying the identifier of the virtual host and the identifier of the virtual machine run in emulation by the virtual host in association with each other on the basis of a target data storage unit storing target data in which the identifier of the virtual host and the identifier of the virtual machine are associated with each other.

14. The control method according to claim 13, further comprising the steps of:
in a case where the operation instruction is an instruction to migrate the virtual machine from the virtual host running the virtual machine in emulation to a different virtual host, inputting the instruction to migrate the virtual machine to the different virtual host to the virtual host running the virtual machine in emulation; and
deleting, from the target data, data in which the virtual machine and the virtual host running the virtual machine in emulation are associated with each other, and inserts, into the target data, data in which the virtual machine and the different virtual host are associated with each other.
